(19) United States
(12) Patent Application Publication
(10) Pub. No.: US 2006/0285332 A1
(43) Pub. Date: Dec. 21, 2006

(54) Compact LED package with reduced field angle

(76) Inventors: Wooi Kin Goon, Penang (MY); Thye Linn Mok, Penang (MY); Kee Yean Ng, Penang (MY); Bee Yin Janet Chua, Perak (MY); Gim Eng Chew, Penang (MY); Rene P. Helbing, Palo Alto, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/153,706

(22) Filed: Jun. 15, 2005

(51) Int. Cl. F21V 7/00

(52) U.S. Cl. 362/327; 362/341

(57) ABSTRACT

A light emitting diode system includes a housing including a light emission opening and a light emitting diode disposed within the housing. A first film layer covers the light emission opening and includes a uniaxial collimating film configured to direct light from the light emitting diode along a first axis.

### BACKGROUND OF THE INVENTION

Current Light Emitting Diode (“LED”) packages have a general wide or narrow field of view (“FOV”). To achieve this currently, a lens is used to collimate the light from the light source/die. This normally adds additional height and area to the LED package. Current problems include an undesirable dome shape caused by an optical lens since a flat-sided and oblong shape is preferred for manufacturability and pick-and-place setups. Additionally, use of an optical lens adds height and size to the overall package thickness.

FIGS. 1A, 1B, and 1C illustrate prior art methods of collimating LED light. As shown in FIG. 1A, LED light source 101 emits light beams 105 through lens 110. Similarly, FIG. 1B illustrates light source 101 emitting light beams 105 through another lens 110 and reflecting light beams 105 off reflector cup 115. Likewise, FIG. 1C illustrates LED light source 101 emitting light beams 105 through a lens 110 and reflected by reflector cup 115 and refracted by lens 110.

Increased height and size are marked problems for big chip LED's, for example, a 1 watt LED of 0.9 mm×0.9 mm, as big chip LED's require big lenses to collimate the emitted light for increased brightness. Increased brightness results from decreasing the FOV of the LED, but with a taller package. Similarly, in a smaller LED package of 1-2 mm but with space restraints on the packaging, an LED with a lens presents design problems due to the lens height. If a reflector cup is used, be it a punched cup or a drilled cup, additional space is required.

What is needed is a way to increase brightness of a LED package with a smaller size.

### SUMMARY OF THE INVENTION

One aspect of the present invention provides a light emitting diode system including a housing including a light emission opening and a light emitting diode disposed within the housing. A first film layer covers the light emission opening and includes a uniaxial collimating film configured to direct light from the light emitting diode along a first axis.

Another aspect of the present invention provides a method of collimating light. The method includes receiving light in a first collimating layer and directing a first portion of the received light through a second collimating layer along a first axis.

Another aspect of the present invention provides a system for collimating light. The system includes means for receiving light in a first collimating layer.

### BRIEF DESCRIPTION OF THE DRAWINGS

FIGS. 1A, 1B, and 1C illustrate prior light emitting diode lighting systems;

FIG. 2 illustrates one embodiment of a light emitting diode lighting systems in accordance with the invention;

FIGS. 3A, 3B, 3C, and 3D are top and side views of a first and second film layer in accordance with one embodiment of the invention;

FIG. 4 illustrates another embodiment of a light emitting diode lighting system in accordance with the invention;

FIG. 5 illustrates another embodiment of a light emitting diode lighting system in accordance with the invention;

FIG. 6 illustrates another embodiment of a light emitting diode lighting system in accordance with the invention;

FIG. 7 illustrates one embodiment of a method for collimating light in accordance with the invention;

FIG. 8 illustrates another embodiment of a method for collimating light in accordance with the invention;

FIG. 9 illustrates another embodiment of a method for collimating light in accordance with the invention; and

FIG. 10 illustrates another embodiment of a method for collimating light in accordance with the invention.

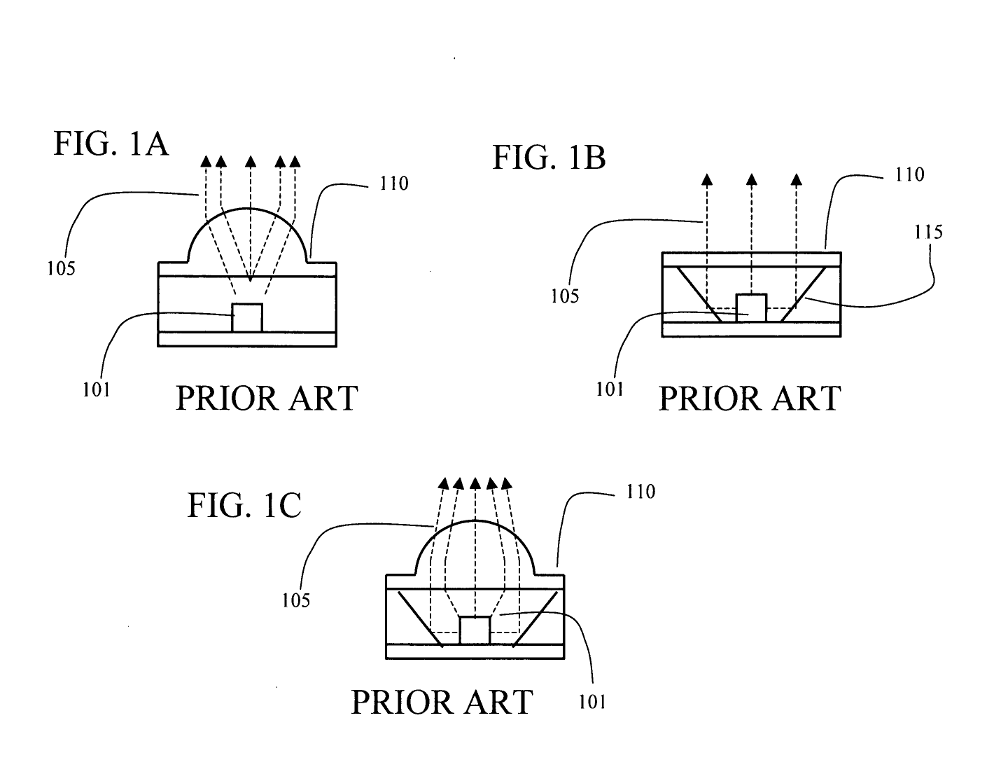

### DETAILED DESCRIPTION

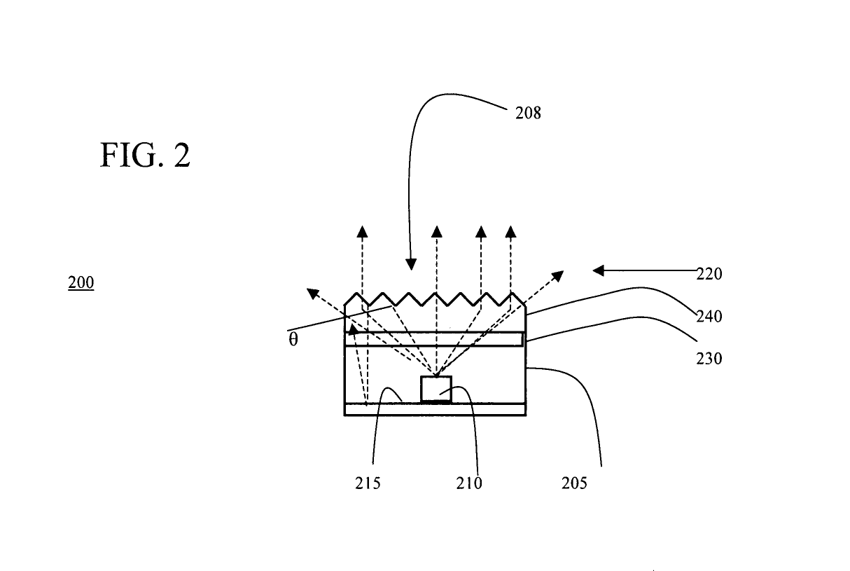

FIG. 2 illustrates one embodiment of a light emitting diode lighting system 200 in accordance with one aspect of the invention. Light emitting diode lighting system 200 includes housing 205, light emitting diode 210 and base 215. Housing 205 includes a light emission opening 208 configured to allow light emitted by light emitting diode 205 to radiate from within housing 205. Housing 205 surrounds light emitting diode 210, such that light emitting diode 210 is disposed within housing 205.

In one embodiment, base 215 includes a mirror-finish layer attached to the housing 205, such that light emitting diode 210 rests upon the mirror-finish layer. A mirror-finish layer is any reflective surface, such as a mirror or other similarly reflective surface. In one embodiment, the mirror-finish layer includes a grooved surface configured to direct incoming light toward a first and second film layer 230, 240 covering the light emission opening 208.

Light emitting diode 210 emits light 220 at a plurality of angles. The light 220 is then refracted by the first and second film layers 230, 240. θ illustrates the critical angle associated with Snell's law: if the angle of the light entering a medium, such as first film layer 230, is greater than θ, then the light has total internal reflection (“TIR”); and if the angle is less than θ, the light is refracted. Additionally, Snell's law posits that if medium A is denser than medium B, light traveling from A into B is focused closer to the normal of the plane between medium A and medium B.

A first and second film layer 230, 240 is disposed over at least a portion of the opening of the housing 205 and the light emission opening 208. In one embodiment, the first and second film layers cover the entire opening, while in other embodiments, the first and second film layers cover only a portion of the opening. In embodiments wherein the first and second film layers cover only a portion of the opening, the first and second film layers may cover the same portion, or at least partially different portions of the opening. The first and second film layers 230, 240 include a uniaxial collimating film configured to direct light emitted from the light emitting diode 210 along a first and second axis, respectively. Thus, light received by the first film layer 230 is directed along a first axis, while light received by the second film layer 240 can be directed along a second axis. The second axis is offset from the first axis. In one embodiment, the first axis is the x-axis, and the second axis is the y-axis. In one embodiment, the uniaxial collimating film is attached to the light emission opening 208. The uniaxial collimating film may be attached to the light emission opening 208 using any appropriate technique, such as a transparent adhesive or optical gel.

In one embodiment, the uniaxial collimating film is implemented as Vikuiti Brightness Enhancement Film (BEF) III-10 T, available from 3M of St. Paul, Minn. In one embodiment, the uniaxial collimating film comprises a transmissive film with a grooved surface. For example, the grooved surface features prismatic properties in certain embodiments. It is preferred that the film is configured to concentrate approximately 40 to approximately 70 percent of the light generated by the light emitting diode to a center, although other configurations are anticipated. It is further preferred that the film is configured to resist deforming on exposure to environmental factors. Environmental factors include, without limitation, heat, cold, dust, and humidity. Maintaining the film in a clean and debris-free state helps to maximize light extraction, and brightness of the emitted light.

Collimating the light in this fashion helps to reduce the FOV of the light emitting diode, and maximize the brightness within the effective FOV.

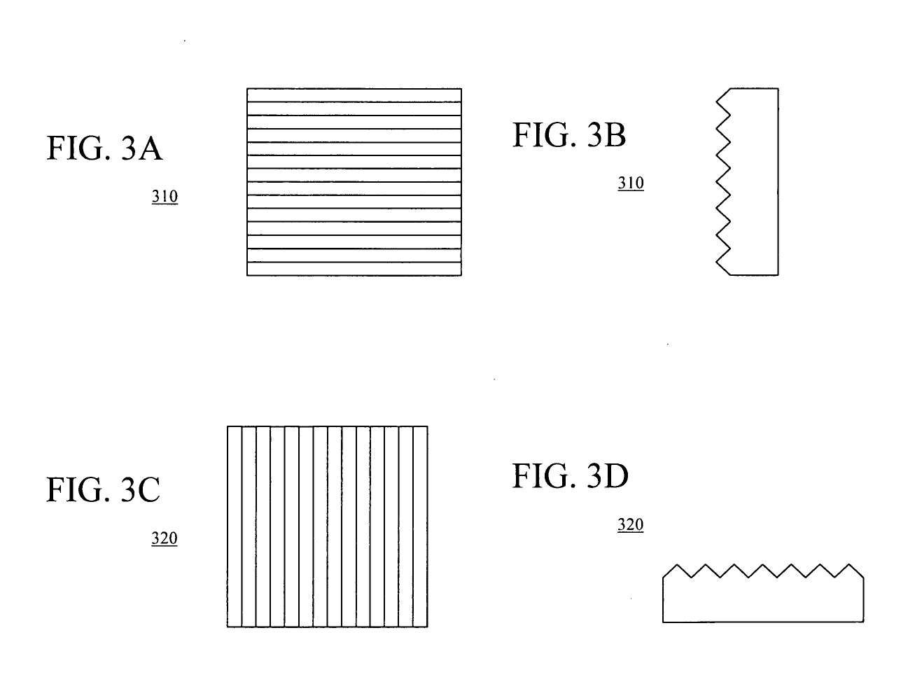

FIGS. 3A and 3B illustrate one embodiment of a first film layer 230, in accordance with one aspect of the invention. FIG. 3A illustrates a top view of the first film layer at 310, while FIG. 3B illustrates a side view of the first film layer. Similarly, FIGS. 3C and 3D illustrate one embodiment of a second film layer 240, in accordance with one aspect of the invention. FIG. 3C illustrates a top view of the second film layer at 320, while FIG. 3D illustrates a side view of the second film layer. As noted above, the axes of film layers 230 and 340 can be offset by 90 degrees or any other angle.

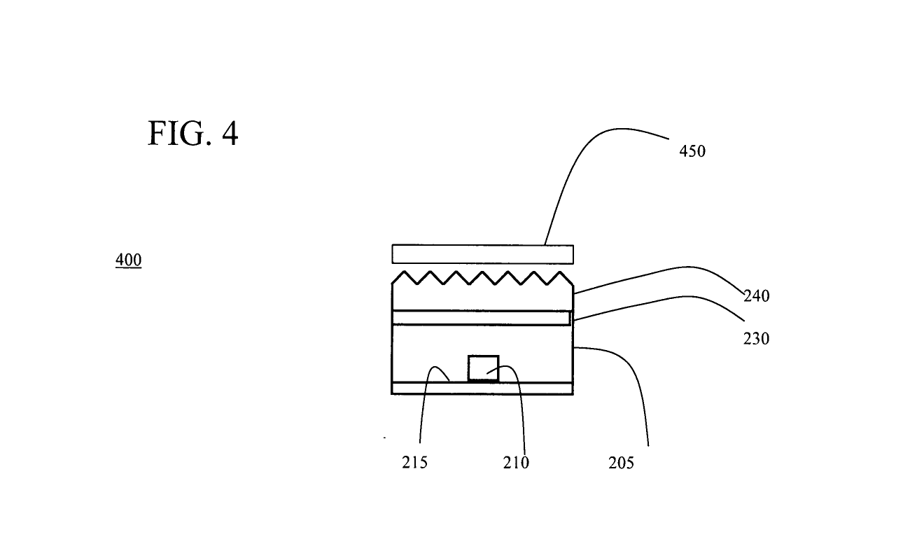

FIG. 4 illustrates another embodiment of a light emitting diode lighting system 400 in accordance with another aspect of the invention. For clarity of illustration, light emitting diode 210 is illustrated not emitting light. In addition to first and second film layers 230, 240, light emitting diode 210, housing 205 and surface 215, system 400 includes an additional light guide 450 configured to diffuse light rays emitting from light emitting diode 210. Light guide 450 is illustrated as receiving light emitted by second film layer 240, but light guide 450 could also be placed between first and second film layers 230, 240, or between light emitting diode 210 and first film layer 230 in other embodiments. Those of ordinary skill in the art will readily recognize that placement of the diffuser will affect the effects of the diffuser. A light guide 450 may comprise any known tool to diffuse light, including liners.

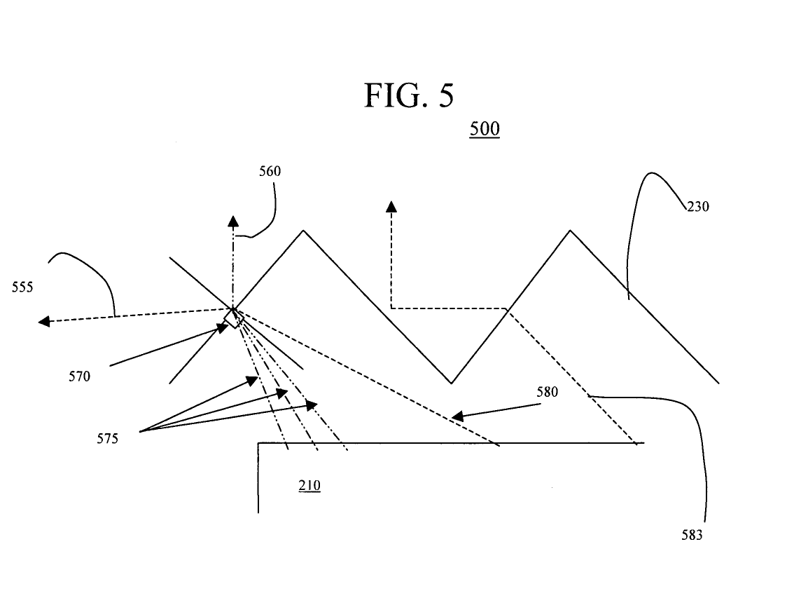

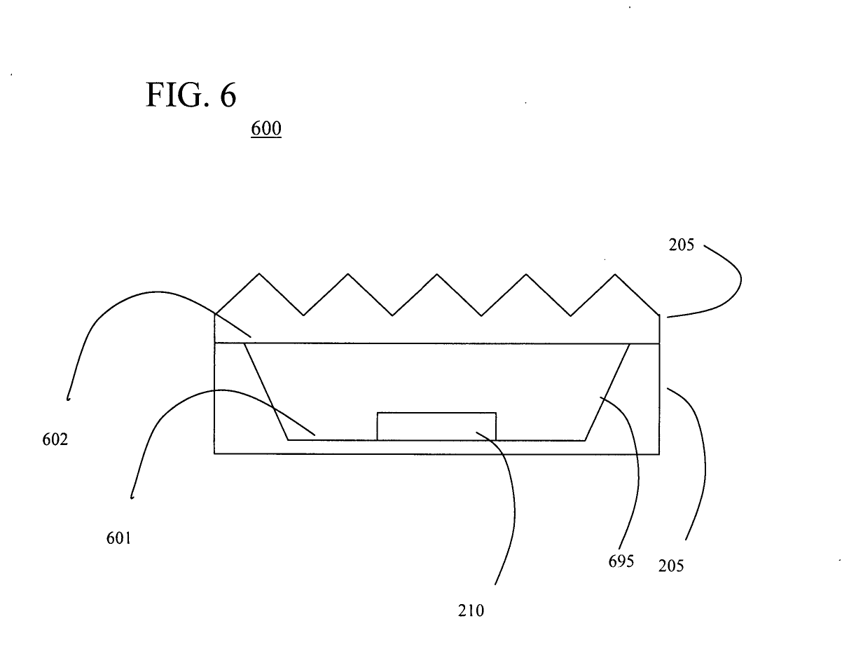

FIG. 5 illustrates a close up side view of a light emitting diode lighting system 500 in accordance with one aspect of the invention. light emitting diode lighting source 210 emits light in the direction of first film layer 230. In one embodiment, light emitting diode 210 is sized to reduce lost light 555 that results from emitted light that does not enter first film layer 230 at a proper angle. For example, sizing the light emitting diode 210 to match the size of the first film layer may provide such a sizing.

FIG. 5 further illustrates the normal angle 570 of light emitted by light emitting diode 210. Light 560 is refracted by first film layer 230 and is emitted from first film layer 230, concentrated on the center of the opening. Incident light 575 is allowable, and in embodiments featuring a reflective surface, incident light 575 will be reflected back toward the first film layer. However, incident light 580 is undesirable and the first film layer, in certain embodiments, is configured to minimize light reflected back toward the emitting light emitting diode.

Light beam 583 is illustrated entering one portion of the first film layer, and being refracted to re-enter the first film layer at a different location. Such refraction will tend to increase light emitted in the desired direction, as a greater portion of the light being emitted will refract at desirable angles, minimizing light loss. For example, upon re-entering the first film layer, light beam 583 may be refracted in a desirable direction (depending on the angle), or light beam 583 may be refracted toward a reflective surface that supports the light emitting diode, or another reflective surface. Other times, even after the refraction, light beam 583 may result in a lost light beam, but at least some light beams 583 will be collimated toward the desired direction.

FIG. 6 illustrates a side view of a light emitting diode system 600 in accordance with another aspect of the invention. System 600 includes light emitting diode 210, housing 205, and first film layer 230. System 600 further includes reflector 695.

Reflector 695 is any surface configured to reflect a substantial portion of incident light. In one embodiment, reflector 695 is a mirror. In another embodiment, reflector 695 is a mirror-finish layer. In yet another embodiment, reflector 695 comprises a grooved surface. In one embodiment, reflector 695 is a sloped reflector. In one embodiment, reflector 695 is a flat surface disposed along a lower surface 601 of the housing 205. In another embodiment, reflector 695 features a smaller opening at the bottom and a larger opening at the top 602, with a sloped surface connecting the bottom and top, termed a “sloped reflector.” In yet another embodiment, reflector 695 is a cup, either drilled or punched, into the housing.

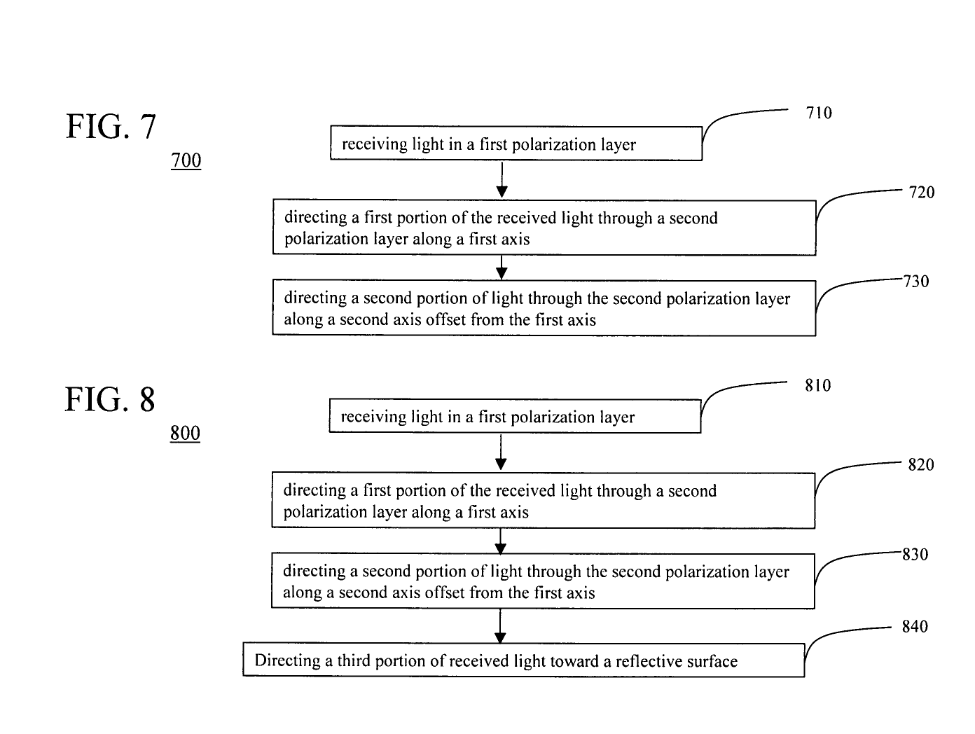

FIG. 7 illustrates one embodiment of a method 700 for collimating light in accordance with one aspect of the invention. Method 700 begins by receiving light in a first collimating layer at step 710. In one embodiment, the received light is emitted or generated by a light emitting diode package. In one embodiment, the first collimating layer is implemented as first film layer 230. The received light is refracted by the first collimating layer and separated into at least two portions including a first and second portion.

A first portion of the received light is directed through a second collimating layer along a first axis at step 720. In one embodiment, the second collimating layer is implemented as second film layer 240. The second collimating layer receives the light refracted by the first collimating layer and directs at least a portion of the light away from the source of the light.

A second portion of the received light is directed through the second collimating layer along a second axis offset from the first axis at step 730. In one embodiment, the first axis is the x-axis. In one embodiment, the second axis is the y-axis. In other embodiments, other axes are chosen for the first and second axis, such as an embodiment where it is desirable to collimate light off-angle from the light emitting diode emitting the light. Directing the received light through the first and second collimating layers collimates the light, increasing the brightness of the light emitted from the light emitting diode as perceived by a viewer.

FIG. 8 illustrates another embodiment of a method 800 for collimating light in accordance with one aspect of the invention. Method 800 includes receiving light in a first collimating layer at step 810. In one embodiment, step 810 is implemented as step 710. A first portion of the received light is directed through a second collimating layer along a first axis at step 820. In one embodiment, step 820 is implemented as in step 720. A second portion of light is directed through the second collimating layer along a second axis offset from the first axis at step 830. In one embodiment, step 830 is implemented as in step 730.

A third portion of the received light is directed toward a reflective surface at step 840. In one embodiment, the third portion of the received light is reflected back toward the housing. For example, the third portion of the received light is reflected toward the mirror-surface layer in one embodiment. In another embodiment, the third portion of the received light is reflected toward a grooved surface.

In one embodiment, receiving light in the first collimating layer includes generating light. In another embodiment, directing the first portion of the received light includes transmitting the received light when the received light has a predetermined angle. In another embodiment, directing the second portion of the received light includes reflecting the received light when the received light does not have the predetermined angle.

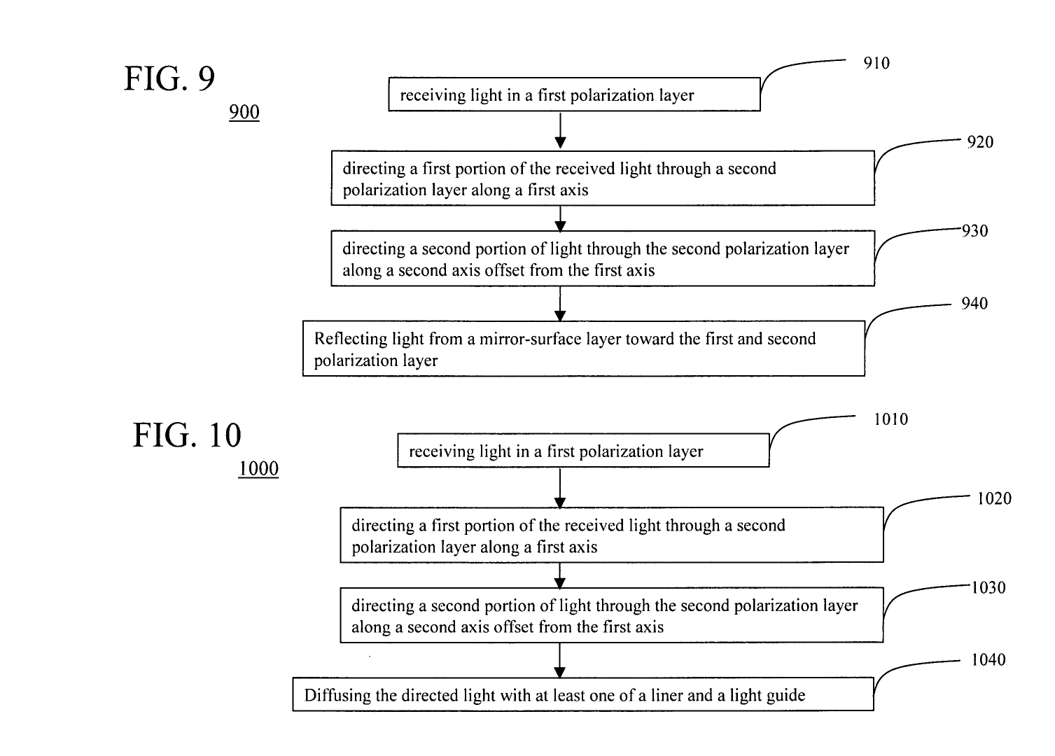

FIG. 9 illustrates another embodiment of a method 900 for collimating light in accordance with one aspect of the invention. Method 900 includes receiving light in a first collimating layer at step 910. In one embodiment, step 910 is implemented as step 710. A first portion of the received light is directed through a second collimating layer along a first axis at step 920. In one embodiment, step 920 is implemented as in step 720. A second portion of light is directed through the second collimating layer along a second axis offset from the first axis at step 930. In one embodiment, step 930 is implemented as in step 730.

Light is reflected from a mirror-surface layer toward the first and second collimating layers at step 940. In one embodiment, the mirror-surface layer is a flat surface supporting the light emitting diode. In another embodiment, the mirror-surface layer is sloped. In yet another embodiment, the mirror-surface layer is a cup supporting the light emitting diode.

FIG. 10 illustrates another embodiment of a method 1000 for collimating light in accordance with one aspect of the invention. Method 1000 includes receiving light in a first collimating layer at step 1010. In one embodiment, step 1010 is implemented as step 710. A first portion of the received light is directed through a second collimating layer along a first axis at step 1020. In one embodiment, step 1020 is implemented as in step 720. A second portion of light is directed through the second collimating layer along a second axis offset from the first axis at step 1030. In one embodiment, step 1030 is implemented as in step 730.

The directed light is diffused with at least one of a liner and a light guide at step 1040. The liner and/or light guide may be placed between the light emitting diode and the first collimating layer, between the first and second collimating layers, or outside the light emitting diode package.

Directing light through the first and second collimating layers, as described with respect to methods 700, 800, 900 and 1000, results in collimating the light received by the first and second collimating layers. Such collimation optimally results in a reduced FOV for a light source directing light beams toward the first and second collimating layers, and an increased effective brightness based on the reduced FOV.

While the embodiments of the invention disclosed herein are presently considered to be preferred, various changes and modifications can be made without departing from the scope of the invention. The scope of the invention is indicated in the appended claims and all changes that come within the meaning and range of equivalents are intended to be embraced therein.

We claim:

1. A light emitting diode system comprising:
a housing including a light emission opening;
an light emitting diode disposed within the housing;
a first film layer disposed across at least a portion of the light emission opening, the first film layer including uniaxial collimating film configured to direct light from the light emitting diode

2. The system of claim 1, wherein the first film layer is configured to direct light from the light emitting diode along a first axis and further comprising:
a second film layer disposed on the first film layer, the second film layer including uniaxial collimating film configured to direct light from the light emitting diode along a second axis offset from the first axis.

3. The system of claim 1 wherein the housing includes a sloped reflector.

4. The system of claim 3 wherein the sloped reflector includes a bottom and a top, and wherein the radius of the bottom of the sloped reflector is smaller than the radius of the top of the sloped reflector.

5. The system of claim 3 wherein the sloped reflector comprises a mirror.

6. The system of claim 1 wherein the light emitting diode is disposed upon a mirror-finish layer attached to the housing.

7. The system of claim 6 wherein the mirror-finish layer includes a grooved surface configured to direct incoming light toward the first and second film layers.

8. The system of claim 1 wherein the uniaxial collimating film comprises a grooved surface.

9. The system of claim 1 wherein the uniaxial collimating film is configured to concentrate approximately 40 to approximately 70 percent of light generated by the light emitting diode to a center.

10. The system of claim 1 wherein the uniaxial collimating film resists deforming on exposure to environmental factors.

11. The system of claim 1 further comprising at least one of a liner and a light guide to diffuse light rays.

12. A method of collimating light, the method comprising:
receiving light in a first collimating layer;
directing a first portion of the received light through a second collimating layer along a first axis; and
directing a second portion of light through the second collimating layer along a second axis offset from the first axis.

13. The method of claim 12 wherein the light is generated by a light emitting diode package, and wherein the first portion of the received light is directed through the second collimating layer along a first axis, and wherein the second portion of light is directed through the second collimating layer along a second axis offset from the first axis.

14. The method of claim 12 further comprising directing a third portion of received light toward a reflective surface of the housing.

15. The method of claim 12 further comprising reflecting light from a mirror-surface layer toward the first and second collimating layers.

16. The method of claim 12 further comprising diffusing the directed light with at least one of a liner and a light guide.

17. The method of claim 12 wherein receiving light in a first collimating layer comprises generating light, and wherein directing a first portion of the received light comprises transmitting the received light when the received light has a predetermined angle, and wherein directing the second portion of the received light comprises reflecting the received light when the received light does not have the predetermined angle.

18. A system for collimating light, the system comprising:
means for receiving light in a first collimating layer;
means for directing a first portion of the received light through a second collimating layer along a first axis; and
means for directing a second portion of light through the second collimating layer along a second axis offset from the first axis.

19. The system of claim 18 further comprising means for diffusing light.

20. The system of claim 18 wherein means for directing a first portion of the received light through a second collimating layer comprises means for directing a first portion of the received light through a second collimating layer along a first axis and wherein means for directing a second portion of light through the second collimating layer comprises means for directing a second portion of light through the second collimating layer along a second axis offset from the first axis.
